(19) United States
(12) Patent Application Publication
(10) Pub. No.: US 2020/0224694 A1
(43) Pub. Date: Jul. 16, 2020

(54) FASTENING ELEMENT FOR FASTENING AN INSULATION TO A WALL

(71) Applicant: Hilti Aktiengesellschaft, Schaan (LI)

(72) Inventors: Stefan MIESCHER, Schaan (LI); Uwe POPP, Widnau (CH); Matthias VON MONKIEWITSCH, Bregenz (AT)

(21) Appl. No.: 16/062,743

(22) PCT Filed: Dec. 7, 2016
(86) PCT No.: PCT/EP2016/079983

§ 371 Date: Jun. 15, 2018

(30) Foreign Application Priority Data
Dec. 18, 2015 (EP) 15201062.5

(51) Int. Cl. F16B 13/04; E04B 1/76

(52) U.S. Cl. CPC F16B 13/045; E04B 1/76

(57) ABSTRACT

A fastening element for fastening a layer-type component, in particular an insulation, to a setting object, in particular to a wall or ceiling of a building, having a setting element, in particular a nail or a screw, the fastening element comprising: a shaft, an opening for receiving the setting element, a stop for positively fastening the setting element, and a terminating element for bearing on an outer side of the layer-type component, wherein the shaft and the terminating element are formed in one piece, it is intended for an insulation as a layer-type component to be able to be fastened to the wall or ceiling as setting object with little work effort even if cracking should occur in the fastening element. This object is achieved in that the shaft comprises at least two segments and an intermediate opening is respectively formed between the at least two segments.

The present invention relates to a fastening element for fastening a layer-type component to a building material, according to the preamble of claim 1, and to a method for fastening a layer-type component to a building material, according to the preamble of claim 15.

In the construction field, it is necessary to fasten insulation, as a layer-type component, to a building's walls or ceilings, as a building material. The insulation is generally used as thermal insulation for the wall or ceiling, the same being a building material of the building, and is attached to the outside of the wall or ceiling. For this purpose, fastening elements are fastened to the wall or ceiling by means of setting elements. Fastening elements which are made of plastic have a shank and a terminal element. The terminal element rests upon an exterior of the insulation after the fastening, and the shank is arranged within a through-hole in the insulation. Setting elements which are made of metal are fastened in the wall or ceiling, and the setting element lies against a stop of the fastening element, such that the fastening element is indirectly fastened by means of the setting element to the building material. As a result, the insulation can be attached to the wall or ceiling, for example.

During the fastening of the fastening elements by means of the setting elements, damage may occur to the shank of the fastening element. Such damage occurs in particular on a first end region of the shank. This damage can cause cracks in the shank. If the cracks increase in size due to the tensile stress on the shank of the fastening element, this can lead to complete failure of the shank, and therefore also of the fastening element used to fasten the layer-type component to the building material.

EP 0 302 909 B1 shows a fastening element with a large-surface-area washer and a tubular extension formed thereon for the passage and telescopically displaceable guidance of a screw, wherein the free inner diameter of the extension over its greatest length approximately corresponds to the outer diameter of the head of the screw being inserted, wherein the washer and the tubular extension are designed as separately manufactured parts, and the tubular extension has a collar, projecting lugs, pins, knobs, or the like on its end which faces the washer, wherein the section of the tubular extension adjoining this end portion approximately corresponds to the clear cross-section of an opening in the washer, wherein the washer is tiltable in the manner of a hinge relative to the tubular extension, and the free end of the extension is tapered to produce a friction fit between the extension and the inserted screw on the shank and/or outer thread diameter of the screw used, such that the tubular extensions can be magazined with inserted screws in advance.

The object of the present invention is therefore to provide a fastening element and a method, wherein an insulation, as a layer-type component, can be reliably fastened with little effort to a wall or ceiling, as a building material, even if there are cracks in the fastening element.

This object is achieved with a fastening element for fastening a layer-type component, in particular an insulation, to a building material, in particular a wall or ceiling of a building, having a setting element, in particular a nail or a screw, the fastening element comprising a shank, an opening for receiving the setting element, a stop for the positive fastening of the setting element, a terminal element for abutment with an exterior of the layer-type component, wherein the shank and the terminal element are constructed as a single piece, wherein the shank comprises at least two segments and an intermediate opening is formed between each of the at least two segments. The shank is subdivided into at least two segments in a section taken perpendicularly to the longitudinal axis of the shank or of the fastening element, and an intermediate opening is formed between each of the at least two segments. Overall, the fastening element thus has one, two, three, four or more intermediate openings. If damage occurs during the fastening of the fastening element to the building material by means of the setting element, in particular on a first end region of the shank, cracks on the shank only lead to a failure of one segment of the shank. However, since the shank comprises a plurality of segments, the fastening element is still able to bear a load, and the fastening element does not fail. Advantageously, damage to the shank, in particular on a first end region of the shank, which leads to cracks on the shank, does not cause complete failure of the shank or of the fastening element. Because the shank is subdivided into individual segments, a crack which forms in one segment therefore only results in the failure of that segment. As such, in the circumferential direction of the shank, on the at least two segments, a crack in one segment cannot propagate over the entire circumferential direction on the shank. As a result, only one segment generally fails, such that due to the at least one other fully functional segment present, the fastening element continues to be sufficiently able to bear a load. In particular, the at least two segments are designed in such a way that even just one segment is adequate for the necessary tensile strength of the fastening element. Preferably, any fastening geometry of the fastening element for the positive fastening of the setting element to the fastening element can be contemplated as a stop.

In an additional embodiment, the at least one intermediate opening is formed as a slot. The at least two segments are ligamentous in shape, such that the at least one intermediate opening between the at least two segments is formed as a slot. The shank has an extension in an axial direction of the fastening element, such that a sufficiently large extension of the at least two segments and of the at least one slot is necessary for sufficient reliability of the shank.

In an additional variant, the at least one slot and/or the at least two segments are formed substantially parallel to a longitudinal axis of the shank.

Preferably, the slot is continuous, such that in a section taken perpendicular to the longitudinal axis of the shank, there is no connection between the segments and/or the shank comprises at least three or four segments. There is no connection in the circumferential direction between the at least two segments, in particular in the regions in which the risk of damage is greatest, such that a crack in one segment cannot propagate to another segment.

In an additional embodiment, the opening and/or the stop are formed on the shank, in particular on a first end region of the shank. The opening, in particular designed as a bore hole with any arbitrary cross-section, allows the passage of a shank of the setting element, and the stop enables the positive fastening of the setting element when a retaining head of the setting element lies against the stop. The opening and the stop in this case are formed on the shank, since the shank has a very small spacing from the building material on the first end region upon the fastening to the building material.

In an additional embodiment, the terminal element is connected to the shank on a second end region of the shank. The second end region of the shank protrudes out of a through-hole of the layer-type component upon the fastening and/or after the fastening, such that the terminal element is connected to the shank on the second end region of the shank.

In an additional embodiment, the terminal element is designed as a disk-shaped contact part. Either the disk-shaped contact part may be formed with recesses, or the disk-shaped contact part may be formed from a solid material without recesses.

In a complementary variant, the opening is formed as a bore hole for the purpose of receiving a setting element shank, and a first end of the bore hole is formed on a first end of the fastening element, and the stop is formed in the region of a second end of the bore hole. The bore hole has any arbitrary cross-section. For example, it has a circular, square or triangular shape in cross-section, and allows the passage of a setting element shank.

In a complementary embodiment, the axial extension of the at least two segments and/or the at least one intermediate opening is at least 10%, 20%, 30%, 50%, 60%, 70% or 80% of the total axial extension of the fastening element. Sufficient axial extension of the at least two segments and/or the at least one intermediate opening is necessary for sufficient protection of the shank against failure due to cracking.

In an additional embodiment, the at least one intermediate opening has a first end and a second end, and the first end is an end facing away from the terminal element and the second end is an end of the at least one intermediate opening which faces the terminal element.

In a further embodiment, the axial extension of the first end of the fastening element up to the second end of the at least one intermediate opening is greater than or equal to the axial extension of the opening. The risk of failure of the shank due to cracking on the shank can be substantially reduced due to this geometric design.

In a complementary variant, the axial extension of the first end of the fastening element up to the second end of the at least one intermediate opening is greater than 1.2, 1.5, or 2 times the axial extension of the opening.

Expediently, an insertion opening for the insertion of the setting element is formed on the terminal element—in particular on a center region of the terminal element—and/or a feed-through channel bounded by the at least two segments is formed within the shank to allow the passage of the setting element. The feed-through channel allows the passage of the setting element to the opening which is arranged inside the shank and/or on the feed-through channel and ends there.

In a complementary embodiment, the entire fastening element is designed as a single piece, and/or the fastening element is—in particular exclusively—made of plastic, preferably thermoplastic. As a result of the single-piece design of the fastening element as a whole, the fastening element can be produced in a particularly inexpensive manner—for example, by injection molding of thermoplastic material. The fastening element is thus produced with an injection molding tool, and due to the geometry of the shank having the at least one segment and the at least one intermediate opening, the injection molding tool can be designed to substantially reduce bending of the injection molding tool inside the shank during the injection molding process, to thereby give individual segments of the shank a substantially constant radial extension. Accordingly, there is substantially no bending of the core of the injection molding tool inside the shank, or such bending is significantly reduced.

A method according to the invention for fastening a layer-type component, in particular an insulation, to a building material, in particular a wall or ceiling of a building, comprising a fastening element and a setting element, has the steps of: passing a setting element through an insertion opening on a terminal element of the fastening element, passing a setting element shank through an opening of the fastening element, fastening the fastening element to the building material by fastening a setting element in the building material and fastening the setting element positively to a stop of the fastening element, bringing a first side of the fastening element to abut against an exterior of the layer-type component such that the layer-type component is held positively by the terminal element, wherein the method is carried out with a fastening element described in this patent application.

In a complementary variant, the layer-type component is first placed on the building material and then the setting element is fastened in the building material—and preferably, the setting element is passed through an opening on the fastening element prior to fastening of the setting element. A bore hole for the setting element in the building material is generally made by means of a drill before the setting of the setting element.

In an additional embodiment, the setting element is a screw, and the screw is fastened in the building material with a screwdriver, in particular a cordless screwdriver, which is used as the setting tool to screw in said setting element.

In a complementary variant, a bore hole is drilled in the building material and then the screw is fastened with an anchor in the bore hole.

In an additional embodiment, the setting element is a bolt or a nail, and the bolt or nail is fastened in the building material with a percussion hammer as a setting device.

In the following, embodiments of the invention will be described in detail with reference to the accompanying drawings, wherein:

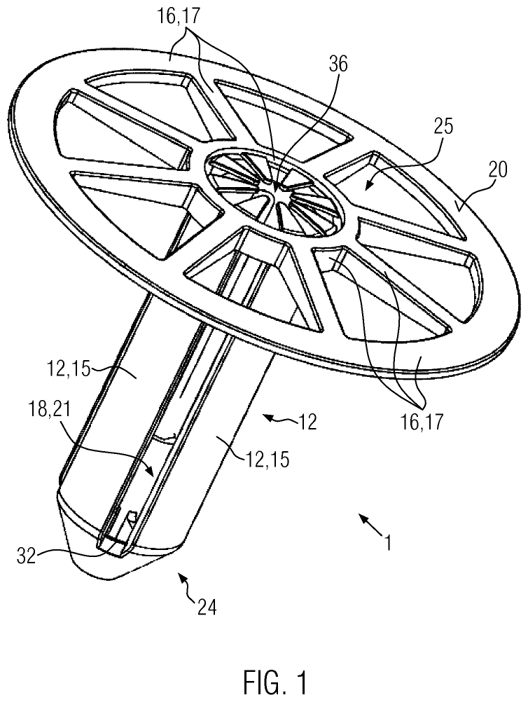

FIG. 1 shows a perspective view of a fastening element,

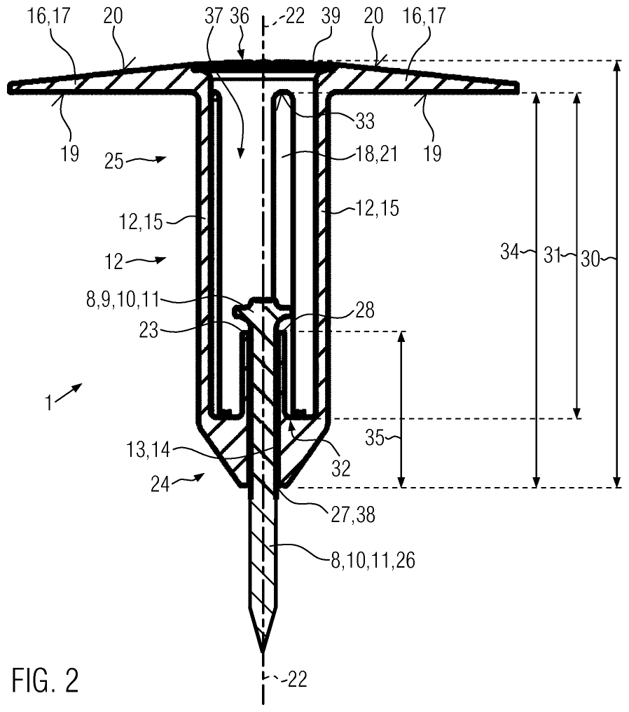

FIG. 2 shows a longitudinal section of the fastening element according to FIG. 1,

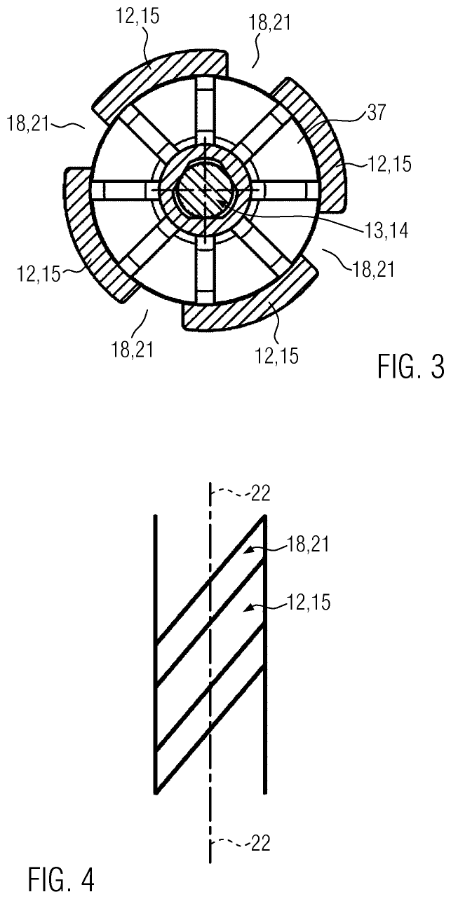

FIG. 3 shows a cross-section of a shank of the fastening element according to FIG. 1,

FIG. 4 shows a side view of the shank of the fastening element in a second embodiment,

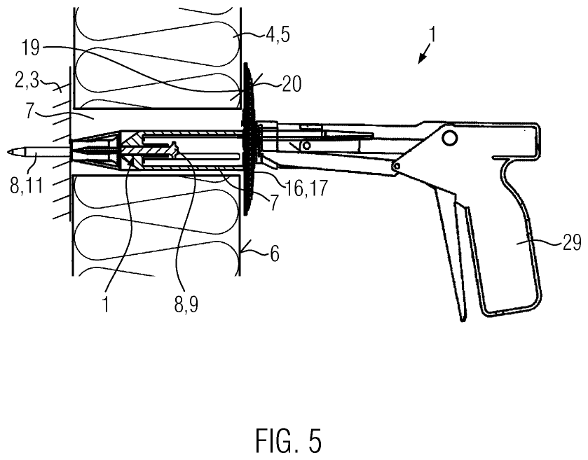

FIG. 5 shows a section taken through a wall and an insulation after the fastening of a bolt used as a setting element.

A fastening element 1 is used for fastening a layer-type component 4, namely an insulation 5, to a wall 3 of a building, as a building material 2. A setting element 8 is formed by a screw 10 or a bolt 11 or nail 11, and a retaining head 9 is formed on the end of the screw 10 or the bolt 11, and the setting element 8 also has a setting element shank 26. The setting element 8 is made of metal. The fastening element 1 is made of plastic.

The single-piece fastening element 1, which is made entirely of thermoplastic, has a rod-like shank 12 and a terminal element 16. The terminal element 16 is disk-shaped and therefore forms a disk-shaped contact part 17. In the disk-shaped contact part 17, individual recesses are formed to reduce the weight of the disk-shaped contact part 17. The terminal element 16 has a first side 19 for the contact and fastening of the layer-type component 4, and a second side 20. The second side 20 of the terminal element 16 is opposite to the first side 19 of the terminal element 16. The shank 12 has a first end region 24 and a second end region 25. When the fastening element 1 is fastened to the wall 3 (FIG. 5), the first end region 24 is formed on the wall 3 and/or the first end region 24 rests on the wall 3. The second end region 25 on the other end region of the shank 12 is arranged outside of a through-hole 7 of the insulation 5, and the terminal element 16 is fastened to the shank 12 on this second end region 25. The fastening element 1 has a first end 38 facing away from the terminal element 16 and a second end 39. The shank 12 is subdivided on an axial section of the shank 12 into four segments 15. The individual segments 15 in this case are formed coaxially with and/or concentrically to an axial longitudinal axis 22 of the shank 12 and the fastening element 1. Intermediate openings 18 are therefore present between the individual segments 15. Due to the ligamentous form of the segments 12 and/or the substantially greater axial extension of the segments 12 compared to their radial extension and/or extension in the circumferential direction, the intermediate opening 18 is formed as a slot 21 between the segments 15. The shank 12 thus comprises four segments and three slots 21 between the individual segments 15. A fastening and guiding device for the setting element 8 is formed by thermoplastic material on the first end region 24 of the shank 12.

The fastening device has a stop 23 for positive contact with the retaining head 9 of the setting element 8. An opening 13 is formed as a guide device for the setting element 8, and the opening 13 is designed as a bore hole 14, the axial extension of which in the direction of the longitudinal axis 22 is substantially greater than the diameter and/or the radial extension of the bore hole 14. The opening 13 has a first end 27 and a second end 28. The second end 28 terminates within a feed-through channel 37 which is bounded by the segments 12 and which is intended for the passage of the setting element 8. The first end 27 of the bore hole 14 and/or the opening 13 is arranged on the wall 3 after the fastening. The intermediate opening 18 has a first end 32 facing away from the terminal element 16 and a second end 33 facing the terminal element 16.

For the fastening of the layer-type component 4, as the insulation 5, to the wall 3, as the building material 2, a bore hole is first made in the wall 3 with a drill, which is not shown. However, the production of this hole is optional and can be omitted. Subsequently, the bolt 11 is inserted into the feed-through channel 36 through an insertion opening 36 on the terminal element 16. Next, the setting element shank 26 is further inserted into the second end 28 of the bore hole 14 until the setting element shank 26 comes to lie against the wall 3, and the first end 27 of the opening 13 and the first end 38 of the fastening device 1 come to lie against the wall 3. Subsequently, the setting element 8 is driven into the building material 2 with a setting device 29—the setting device 29 being designed as an impact hammer, by way of example—until the retaining head 9 lies against the stop 23. Due to the thickness of the insulation 5, the first side 19 of the terminal element 16 then lies against an outer side 6 of the layer-type component 4, such that the layer-type component 4 is held between the wall 3 and the first side 19 of the terminal element 16 with a positive and/or force-fit connection (FIG. 5).

The axial extension 31 of the segments 15 and the intermediate openings 18 corresponds approximately to 70% of the total axial extension 30 of the fastening element 1. A majority of the shank 12 is thus subdivided by means of the segments 15 into the segments 15 and the intermediate openings 18. If cracks arise on the shank 12, in particular on the first end region 24 of the shank 12 during the fastening of the setting elements 8 in the wall 3, these cracks do not lead to a failure of the shank 12 as a whole when these cracks propagate. This is because, when there is a crack in one segment 15, this crack cannot propagate to the other segments 15 in the circumferential direction. A failure of the fastening element 1 due to cracking is thus substantially ruled out, because usually only one, or at most two, segments 15 are damaged by cracking when a crack arises. As a result, two or three load-bearing segments 15 are present which can transmit the required tensile forces from the outside 6 of the layer-type component 4 to the setting element 8. The axial extension 34 from the first end 38 of the fastening element 1, and/or from the first end 27 of the bore hole 14, to the second end 33 of the intermediate opening 18 is greater than the axial extension 35 of the opening 13 as the bore hole 14. This constructively ensures that the fastening element 1 substantially does not fail as a result of cracking.

Overall, significant advantages are associated with the fastening element 1 according to the invention. When the setting element 8 is driven into the wall 3, greater forces can be transmitted to the shank 12 in the region of the second end 28 of the bore hole 14 by the retaining head 9. This can lead to cracking of the first end region 24 of the shank 12. The region of the shank 12 on the first end 27 of the bore hole 14 has a great thickness, such that in this region of the shank 12 the cracks do not normally lead to a failure of the fastening element 1. However, these cracks can also propagate to the remaining region of the shank 12. However, cracks in this remaining region of the shank 12 do not lead to a failure of the fastening element 1 on the remaining shank 12 since the remaining shank 12 is subdivided into the segments 15, and thus, when cracking occurs on this remaining part of the shank 12, typically only one, or at most two, segments 15 are damaged, and also a propagation of the cracking from one segment 15 to another segment 15 is prevented. As a result, the fastening element 1 has a sufficient number of segments 15 able to bear load. The thickness of the segments 15—that is, the radial extension of the segments 15 perpendicular to the longitudinal axis 22—is designed so that even one or two segments 15 can safely and reliably absorb the necessary tensile forces.

1. A fastening element for fastening a layer-type component to a building material having a setting element wherein the fastening element comprises:
a shank;
an opening for receiving the setting element;
a stop for positive fastening of the setting element;
a terminal element for contacting an outer side of the layer-type component,
wherein the shank and the terminal element are constructed as a single piece;
wherein
the shank comprises at least two, segments, and at least one intermediate opening formed between each of the at least two segments.

2. The fastening element according to claim 1,
wherein
the at least one intermediate opening is a slot.

3. The fastening element according to claim 2,
wherein
the at least one slot and/or the at least two segments are formed essentially parallel to a longitudinal axis of the shank.

4. The fastening element according to claim 2,
wherein
the slot is continuous, such that in a section taken perpendicular to a longitudinal axis of the shank, there is no connection between the at least two segments,
and/or
the shank comprises at least three or four segments.

5. The fastening element according to claim 1,
wherein
the opening for receiving the setting element and/or the stop are formed on the shank.

6. The fastening element according to claim 1,
wherein
the terminal element is connected to the shank on a second end region of the shank.

7. The fastening element according to claim 1,
wherein
the terminal element is a disk-shaped contact part.

8. The fastening element according to claim 1,
wherein
the opening for receiving the setting element is designed as a bore hole for receiving a setting element shank, and a first end of the bore hole is formed on a first end of the fastening element, and the stop is formed in a region of a second end of the bore hole.

9. The fastening element according to claim 1,
wherein
an axial extension of the at least two segments and/or the at least one intermediate opening is at least 10% of a total axial extension of the fastening element.

10. The fastening element according to claim 1,
wherein
the at least one intermediate opening has a first end and a second end, and the first end is an end which faces away from the terminal element, and the second end is an end of the at least one intermediate opening which faces the terminal element.

11. The fastening element according to claim 10,
wherein
an axial extension from a first end of the fastening element to a second end of the at least one intermediate opening is greater than or equal to an axial extension of the opening for receiving the setting element.

12. The fastening element according to claim 10,
wherein
an axial extension from a first end of the fastening element to the second end of the at least one intermediate opening is greater than 1.2 times an axial extension of the opening for receiving the setting element.

13. The fastening element according to claim 1,
wherein
an insertion opening for the insertion of the setting element is formed on the terminal element,
and/or
a feed-through channel bounded by the at least two segments is formed within the shank to allow the passage of the setting element.

14. The fastening element according to claim 1,
wherein
the fastening element as a whole is formed as a single piece,
and/or
the fastening element is formed of plastic.

15. A method for fastening a layer-type component to a building material having a fastening element and a setting element, wherein the fastening element comprises:
a shank;
an opening for receiving the setting element
a stop for positive fastening of the setting element
a terminal element for contacting an outer side of the layer-type component wherein the shank and the terminal element are constructed as a single piece;
wherein
the shank comprises at least two segments; and at least one intermediate opening formed between each of the at least two segments,
the method comprising:
passing the setting element through an insertion opening on the terminal element of the fastening element;
passing a setting element shank through the opening for receiving the setting element of the fastening element;
fastening the fastening element to the building material by fastening the setting element in the building material and fastening the setting element positively to a stop of the fastening element;
bringing a first side of the terminal element to abut against an exterior of the layer-type component such that the layer-type component is held positively by the terminal element.

16. The fastening element according to claim 5, wherein the opening for the setting element and/or the stop are formed on a first end region of the shank.

17. The fastening element according to claim 13, wherein the insertion opening for the insertion of the setting element is formed in a center region of the terminal element.

18. The fastening element according to claim 14, wherein the fastening element is formed exclusively of plastic.

19. The fastening element of claim 18, wherein the plastic is thermoplastic.

20. The fastening element according to claim 11, wherein an axial extension from a first end of the fastening element to the second end of the at least one intermediate opening is greater than 1.2 times an axial extension of the opening for receiving the setting element.
